(19) United States
(12) Patent Application Publication
(10) Pub. No.: US 2024/0074563 A1
(43) Pub. Date: Mar. 7, 2024

(54) AUTOMATIC MAKEUP MACHINE, METHOD, PROGRAM, AND CONTROL DEVICE

(71) Applicant: SHISEIDO COMPANY, LTD., Tokyo (JP)

(72) Inventors: Mieko NASU, Tokyo (JP); Daisuke KAMIWANO, Tokyo (JP); Maro TOKUSHIGE, Tokyo (JP); Takahiro SUZUKI, Tokyo (JP); Takashi MARUYAMA, Tokyo (JP)

(21) Appl. No.: 17/754,662

(22) PCT Filed: Sep. 30, 2020
(86) PCT No.: PCT/JP2020/037106

§ 371 Date: Apr. 8, 2022

(30) Foreign Application Priority Data
Oct. 11, 2019 (JP) 2019-187736

(51) Int. Cl. A45D 44/00; A45D 34/04; A45D 44/10

(52) U.S. Cl. CPC A45D 44/005; A45D 34/04; A45D 44/10; A45D 2200/057

(57) ABSTRACT

According to the present disclosure, makeup is put on based on the characteristics of the face of the person who is having the makeup put on. A control part and an application part are provided, where the control part includes: an area determining part configured to determine an area to apply a cosmetic product, based on a selected application pattern and at least two application characteristic points on a face; and a command part configured to command an application device to apply the cosmetic product to the area, and where the application part applies the cosmetic product to the area as commanded by the control part.

### TECHNICAL FIELD

The present disclosure relates to an automatic makeup machine, a method, a program, and a control device.

### BACKGROUND ART

Heretofore, devices that put makeup on people have been disclosed. For example, patent document 1 discloses a method or device for putting makeup on or applying color to the human body.

When a person puts makeup on his/her face or on another person's face, the person who applies the makeup determines, for example, the shape of an area to apply a cosmetic product, the position of the area to apply the cosmetic product, and so forth, depending on the face of the person to whom the makeup is applied (hereinafter this linking of the shape of an area to apply a cosmetic product and its position on the face will be referred to as an “application pattern”). For example, when working on the cheeks, the person who applies the makeup might blush the cheeks of the person to whom the makeup is applied, elliptically along his/her cheekbones, or blush the cheeks of the person to whom the makeup is applied, horizontally from the center of his/her cheeks.

### CITATION LIST

### Patent Documents

[Patent Document 1] Japanese Unexamined Patent Application Laid-Open No. 2004-501707

### SUMMARY OF INVENTION

### Technical Problem

Patent Document 1 simply discloses applying treatment products according to the design that the user selects (see, for example, paragraph of Patent Document 1), and, if a number of users select the same design, that design will be applied to all of the users as is. In other words, no adjustments are made to the design in accordance with the person to whom makeup is to be applied.

### Solution to Problem

It is therefore an object according to at least one embodiment of the present disclosure to apply makeup based on the characteristics of the face of the person who is having the makeup put on.

According to at least one aspect of the present disclosure, a control part and an application part are provided, where the control part includes: an area determining part configured to determine an area to apply a cosmetic product, based on a selected application pattern and at least two application characteristic points on a face; and a command part configured to command an application device to apply the cosmetic product to the area, and where the application part applies the cosmetic product to the area as commanded by the control part.

### Advantageous Effects of the Invention

According to the present disclosure, it is possible to apply makeup based on the characteristics of the face of the person who is having the makeup put on.

### BRIEF DESCRIPTION OF DRAWINGS

FIG. 1 is a diagram showing an example overall structure of an automatic makeup machine according to one embodiment of the present disclosure;

FIG. 2 is an example functional block diagram of an automatic makeup machine according to one embodiment of the present disclosure;

FIG. 3 is a diagram for explaining application characteristic points and face-stabilizing characteristic points according to one embodiment of the present disclosure;

FIG. 4 shows example application patterns according to one embodiment of the present disclosure;

FIG. 5 is a diagram for explaining an affine transformation of an application pattern according to one embodiment of the present disclosure;

FIG. 6 is an example of stabilizing the user's face according to one embodiment of the present disclosure;

FIG. 7 is a flowchart showing an example pre-registration process of application characteristic points according to one embodiment of the present disclosure;

FIG. 8 is a flowchart showing an example pre-registration process of face-stabilizing characteristic points according to one embodiment of the present disclosure;

FIG. 9 is a flowchart showing an example makeup process according to one embodiment of the present disclosure;

FIG. 10 is a flowchart showing an example area determining process according to one embodiment of the present disclosure; and

FIG. 11 is a block diagram showing an example hardware structure of processing units and processing devices in the automatic makeup machine according to one embodiment of the present disclosure.

### DESCRIPTION OF EMBODIMENTS

<Overall Structure Diagram>

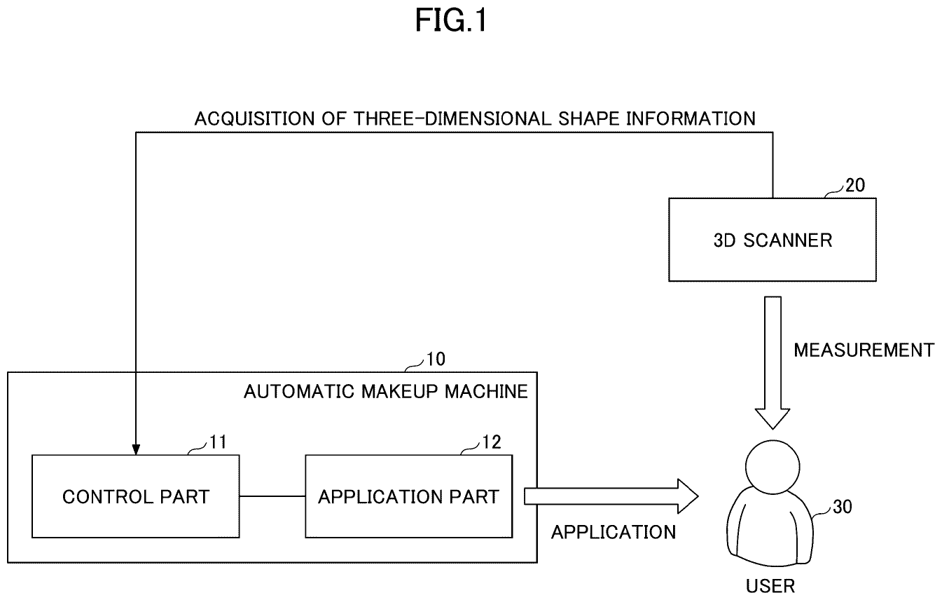

FIG. 1 is a diagram showing an example overall structure of an automatic makeup machine 10 according to one embodiment of the present disclosure. Assume that the automatic makeup machine 10 puts makeup on a user 30. As shown in FIG. 1, the automatic makeup machine 10 includes a control part 11 and an application part 12. The control part 11 and the application part 12 are communicably connected. Now, each of these will be described below.

Note that, although this specification will primarily describe a case where the cosmetic product the automatic makeup machine 10 applies is blush, the automatic makeup machine 10 may apply any cosmetic products, including foundation, eyebrow, eyeshadow, lipstick and so forth.

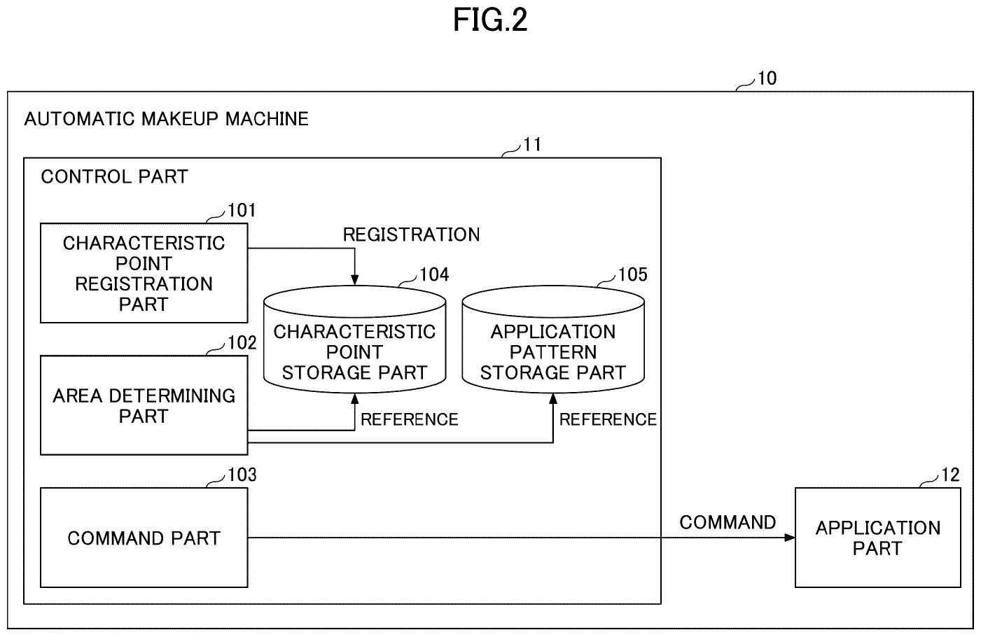

The control part 11 determines the area to apply a cosmetic product, based on at least two application characteristic points on the user 30's face, and an application pattern that is selected. In addition, the control part 11 commands the application part 12 to apply the cosmetic product to the determined area. To be more specific, the control part 11 identifies at least two application characteristic points on the user 30's face, based on information (X-axis, Y-axis, and Z-axis coordinate information) about the three-dimensional shape of the user 30's face, measured by a 3D scanner 20. Later in the following description, the control part 11 will be described in more detail with reference to FIG. 2.

The application part 12 applies the cosmetic product to the area on the surface of the user 30's face, as commanded by the control part 11. For example, the application part 12 can apply the cosmetic product by spraying the cosmetic product over the user 30's face using an airbrush. In this case, the automatic makeup machine 10 does not touch the user 30's face, so that it is hygienic.

Note that the application part 12 can also be configured to apply a cosmetic product by touching the user 30's face with the cosmetic product, using any makeup tools as needed (for example, makeup sponges, puffs, tips, brushes, and so forth).

Although, with reference to FIG. 1, the control part 11 and the application part 12 have been described above as one device (that is, the automatic makeup machine 10), they may be implemented using separate devices as well (for example, a makeup control device and a coating device). Furthermore, the automatic makeup machine 10 may have the functions of the 3D scanner 20.

<Functional Structure>

FIG. 2 is an example functional block diagram of the automatic makeup machine 10 according to one embodiment of the present disclosure. The control part 11 of the automatic makeup machine 10 can include a characteristic point registration part 101, an area determining part 102, a command part 103, a characteristic point storage part 104, and an application pattern storage part 105. The control part 11 of the automatic makeup machine 10 can function as the characteristic point registration part 101, the area determining part 102, and the command part 103, by executing programs. Now, each of these will be described below.

The characteristic point registration part 101 identifies at least two application characteristic points on the user 30's face, and face-stabilizing characteristic points on the user 30's face, and register these characteristic points. Now, these “application characteristic points” and “face-stabilizing characteristic points” will be described separately.

<Application Characteristic Points>

The application characteristic points are characteristic points for use for determining the area to apply a cosmetic product. The characteristic point registration part 101 acquires information (X-axis, Y-axis, and Z-axis coordinate information) about the three-dimensional shape of the face of the user 30, measured using the 3D scanner 20. Furthermore, the characteristic point registration part 101 identifies characteristic points that indicate parts of the user 30's face such as contours, eyes, nose, mouth, and eyebrows, based on the information about the three-dimensional shape of the user 30's face. Furthermore, the characteristic point registration part 101 identifies at least two application characteristic points from the characteristic points indicating parts of the user 30's face such as contours, eyes, nose, mouth, and eyebrows. In addition, the characteristic point registration part 101 registers information (X-axis, Y-axis, and Z-axis coordinate information) about at least two application characteristic points with the characteristic point storage part 104.

<Face-Stabilizing Characteristic Points>

The face-stabilizing characteristic points are characteristic points for use for calculating the coordinates for specifying the area to apply a cosmetic product. As will be described later, when a cosmetic product is applied, the coordinates for specifying the area to apply the cosmetic product are calculated based on the coordinates of face-stabilizing characteristic points, and the relative positional relationship between at least two application characteristic points and the face-stabilizing characteristic points.

The characteristic point registration part 101 acquires the information (X-axis, Y-axis, and Z-axis coordinate information) about the three-dimensional shape of the user 30's face, measured using the 3D scanner 20. Furthermore, the characteristic point registration part 101 identifies characteristic points that indicate parts of the user 30's face such as contours, eyes, nose, mouth, and eyebrows, based on the information about the three-dimensional shape of the user 30's face. In addition, the characteristic point registration part 101 identifies face-stabilizing characteristic points (for example, two face-stabilizing characteristic points), which are different from the application characteristic points, from among the characteristic points indicating parts of the user 30's face such as contours, eyes, nose, mouth, and eyebrows. Furthermore, the characteristic point registration part 101 registers information (X-axis, Y-axis, and Z-axis coordinate information) about the face-stabilizing characteristic points with the characteristic point storage part 104.

The face-stabilizing characteristic points are preferably characteristic points that are less likely to be influenced by the increase and decrease of body weight, changes of expression, and so forth. Note that the face-stabilizing characteristic points might match with the application characteristic points.

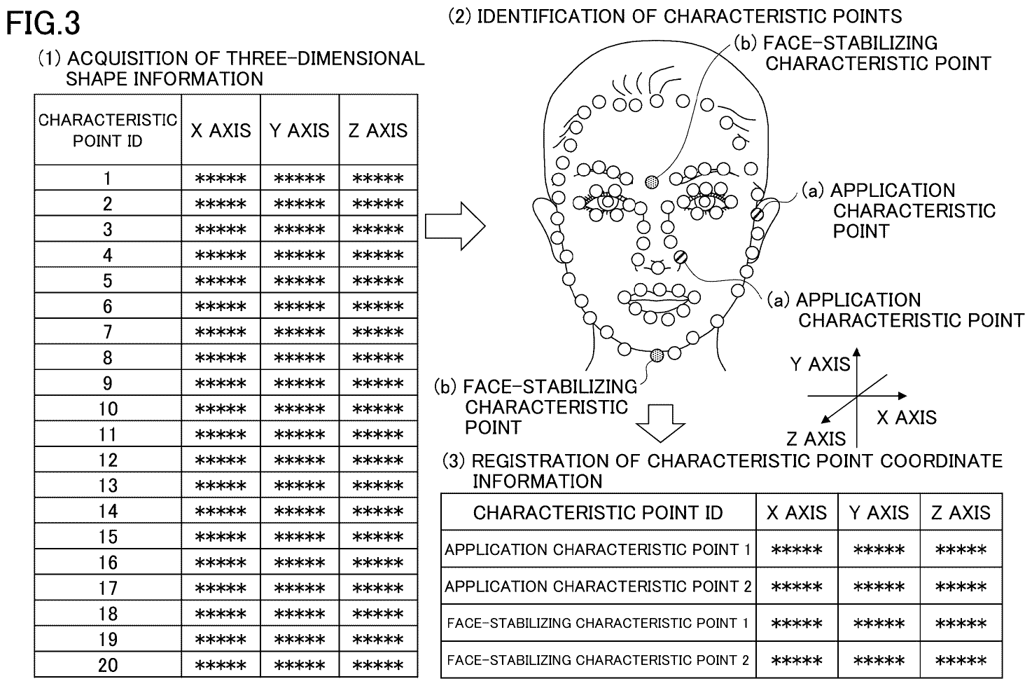

FIG. 3 is a diagram for explaining application characteristic points and face-stabilizing characteristic points according to one embodiment of the present disclosure.

As shown as “(1) ACQUISITION OF THREE-DIMENSIONAL SHAPE INFORMATION” in FIG. 3, information (X-axis, Y-axis, and Z-axis coordinate information) about the three-dimensional shape of the user 30's face, which is measured using the 3D scanner 20, is acquired.

Next, as shown as “(2) IDENTIFICATION OF CHARACTERISTIC POINTS” in FIG. 3, characteristic points that indicate parts of the user 30's face such as contours, eyes, nose, mouth, and eyebrows are identified. Then, at least two application characteristic points (“(A) APPLICATION CHARACTERISTIC POINTS” in FIG. 3) are identified among the characteristic points indicating parts of the user 30's face such as contours, eyes, nose, mouth, and eyebrows. Furthermore, face-stabilizing characteristic points (“(B) FACE-STABILIZING CHARACTERISTIC POINTS” in FIG. 3) are identified among the characteristic points indicating parts of the user 30's face such as contours, eyes, nose, mouth, and eyebrows.

Next, as shown as “(3) REGISTRATION OF CHARACTERISTIC POINT COORDINATE INFORMATION” in FIG. 3, X-axis, Y-axis, and Z-axis coordinate information of the application characteristic points and face-stabilizing characteristic points are registered. In FIG. 3, at least two application characteristic points are registered for determining the area to apply one type of cosmetic product (for example, blush), but it is also possible to register at least two application characteristic points for determining each area when applying a number of types of cosmetic products (for example, blush, foundation, eyebrow, eyeshadow, lipstick, and so forth) (that is, application characteristic points may be registered for each type of cosmetic product).

Note that characteristic points (that is, characteristic points to indicate parts of the user 30's face such as contours, eyes, nose, mouth, and eyebrows) other than the application characteristic points and face-stabilizing characteristic points may be registered. In this case, since all the characteristic points of the user 30 are already identified, it is easy to add and register new application characteristic points.

Referring back to FIG. 2, the at least two application characteristic points identified by the characteristic point registration part 101 are stored in the characteristic point storage part 104. Furthermore, the face-stabilizing characteristic points identified by the characteristic point registration part 101 are stored in the characteristic point storage part 104.

Information about application patterns (the types of shapes of areas to apply cosmetic products and their positions on the face) is stored in the application pattern storage part 105. To be more specific, for every application pattern, information about the shape of an area to apply a cosmetic product and the positional relationship between the area to apply the cosmetic product and application characteristic points is stored. Note that the information of application patterns may be two-dimensional information (which is X-axis and Y-axis coordinate information, that is, information that does not take into account the unevenness of the face) or may be three-dimensional information (which is X-axis, Y-axis, and Z-axis coordinate information, that is, information that takes into account the unevenness of the face).

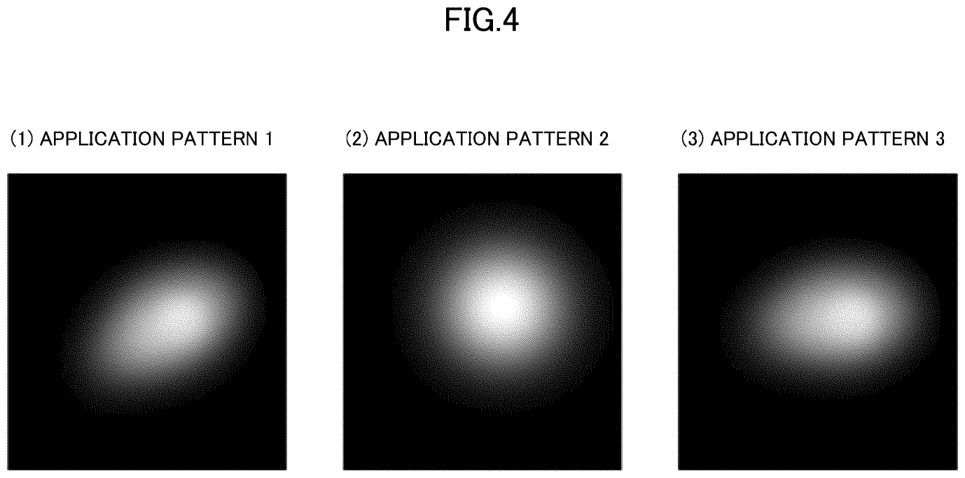

FIG. 4 shows example application patterns according to one embodiment of the present disclosure. For example, when blush is the cosmetic product that the automatic makeup machine 10 applies, information about the shapes of, for example, (1) an application pattern that gives a “cool” impression such as application pattern 1 in FIG. 4, (2) an application pattern that gives a “cute” impression such as application pattern 2, and (3) an application pattern that gives a “fresh” impression such as application pattern 3, and their positions on the face, is stored in the application pattern storage part 105.

Referring back to FIG. 2, the area determining part 102 determines the area to apply the cosmetic product, based on at least two application characteristic points on the face and the application pattern that is selected. Below, <Selection of application pattern>, <Affine transformation of application pattern>, and <Calculation of coordinates> will be described in order.

<Selection of Application Pattern>

The area determining part 102 selects the application pattern. Hereinafter, <<Selection by user>> and <<Automatic selection>> will be described separately.

<<Selection by User>>

The area determining part 102 selects the application pattern following the user 30's choice. To be more specific, the area determining part 102 makes the display means of the automatic makeup machine 10 (or, if the automatic makeup machine 10 is implemented using separate devices (a control device and an application device), the control device's display means) display information of a number of application patterns. For example, information about the impression that each application pattern gives (for example, “COOL,” “CUTE,” and “FRESH” in FIG. 4), and information about each application pattern's shape and position on the face are displayed. Furthermore, the area determining part 102 acquires information about the application pattern, which the user 30 chooses using the input means of the automatic makeup machine 10 (or, if the automatic makeup machine is implemented using separate devices (a control device and an application device), the control device's input means). Also, the area determining part 102 selects the application pattern chosen by the user 30 as the application pattern for determining the area to apply the cosmetic product.

<<Automatic Selection>>

The area determining part 102 selects an application pattern based on characteristic points on the face of the user 30. To be more specific, the area determining part 102 selects an application pattern that is suitable for the user 30's face, based on characteristic points that indicate parts of the user 30's face such as contours, eyes, nose, mouth, and eyebrows.

For example, the area determining part 102 can select an application pattern suitable for the user 30's face, based on pre-registered correspondences between characteristic points that indicate facial parts such as contours, eyes, nose, mouth, and eyebrows, and application patterns suitable for that face. Note that the area determining part 102 may use AI (Artificial Intelligence) to infer an application pattern that is suitable for the face from characteristic points that indicate facial parts such as contours, eyes, nose, mouth, and eyebrows.

<Affine Transformation of Application Pattern>

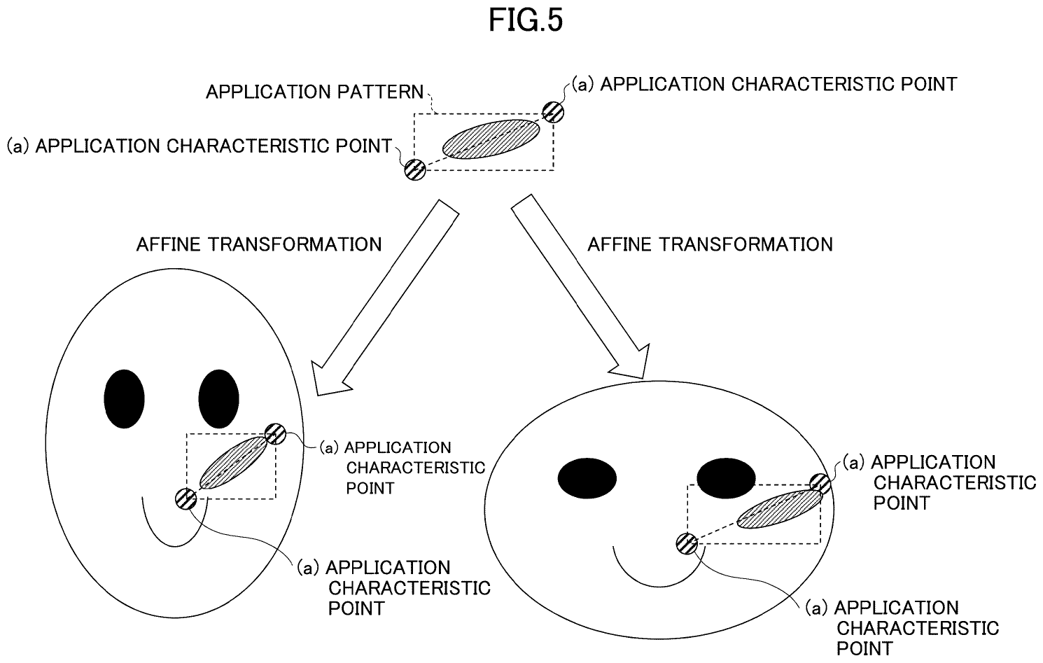

Next, an affine transformation of the application pattern will be explained. The area determining part 102 performs an affine transformation of the selected application pattern, based on the positions of at least two application characteristic points on the face of the user 30. Now, the affine transformation of the application pattern will be described in detail below with reference to FIG. 5.

FIG. 5 is a diagram for explaining an affine transformation of an application pattern, according to one embodiment of the present disclosure.

The area determining part 102 performs an affine transformation of the application pattern on the user 30′ face. To be more specific, the area determining part 102 does at least one of the following on the user 30's face: translate the application pattern; scale up the application pattern; scale down the application pattern; and rotate the application pattern, and has at least two application characteristic points on the face of the user 30 and at least two application characteristic points of the application pattern overlaid on each other.

To describe this in more detail, the area determining part 102 refers to information of the application pattern selected in the application pattern storage part 105 in the above <<Selection of application pattern>>. That is, the area determining part 102 refers to information about the shape of the area to apply the cosmetic product, and the positional relationship between the area to apply the cosmetic product and the application characteristic points.

The area determining part 102 can scale up or scale down the shape of the application pattern (that is, the shape of the area to apply the cosmetic product) in the up-down direction or in the left-right direction, and place this application pattern on the user 30's face, so that the user 30's application characteristic points and the application pattern's application characteristic points overlap each other. For example, the area determining part 102 can scale up or scale down the shape of the application pattern in the up-down direction (Y-axis direction) based on the positions of at least two application characteristic points on the user 30's face. Furthermore, the area determining part 102 can scale up or scale down the shape of the application pattern in the left-right direction (X-axis direction) based on the positions of at least two application characteristic points on the face of the user 30.

Furthermore, the area determining part 102 can rotate the application pattern and place this application pattern on the user 30's face so that the user 30's application characteristic points and the application pattern's application characteristic points overlap each other.

### Calculation of Coordinates

Next, the calculation of coordinates will be explained. Below, a case in which the cosmetic product is applied at the same time as application characteristic points are identified, and a case in which the cosmetic product is applied separately after application characteristic points are identified will be described.

<<Case in which Cosmetic Product is Applied at the Same Time as Application Characteristic Points are Identified>>

The area determining part 102 calculates the coordinates for specifying the area to apply the cosmetic product, based on the coordinates of at least two application characteristic points (that is, the area according to the application pattern that is affine-transformed and placed on the face).

<<Case in which Cosmetic Product is Applied Separately after Application Characteristic Points are Identified>>

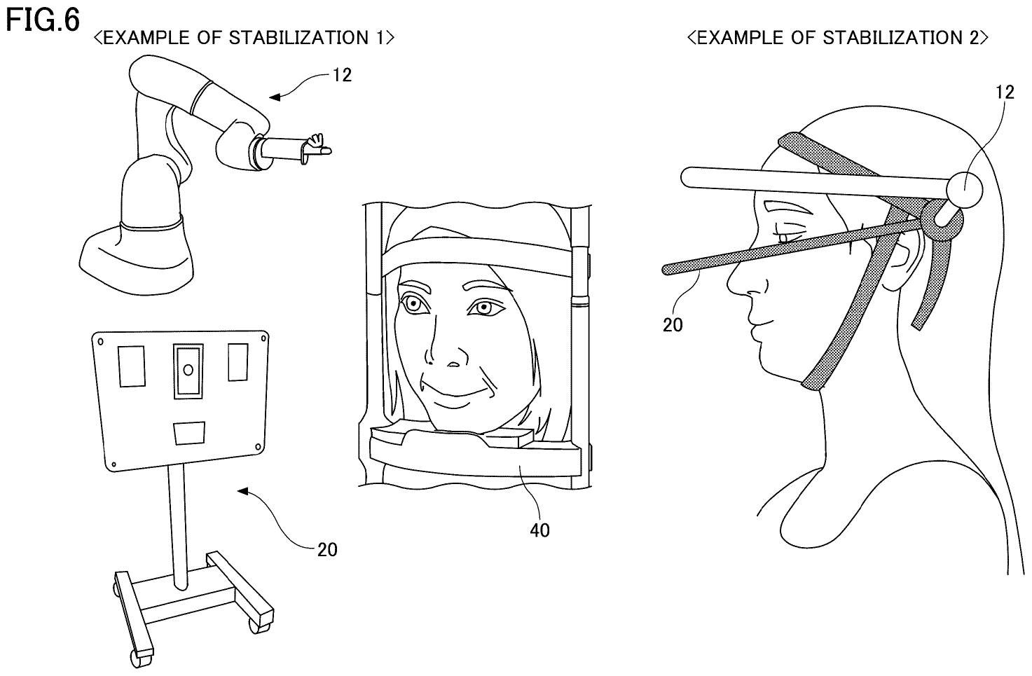

The area determining part 102 calculates the coordinates for specifying the area to apply the cosmetic product (that is, the area according to the application pattern that is affine-transformed and placed on the face), based on the coordinates of the face-stabilizing characteristic points, and the relative positional relationship between at least two application characteristic points and the face-stabilizing characteristic points. Below, the calculation of coordinates will be described in detail with reference to FIG. 6.

FIG. 6 shows examples of stabilizing the face of the user 30 according to one embodiment of the present disclosure.

<Example of Stabilization 1 (when the User 30's Face is Aligned with a Predetermined Position)>

As shown as <EXAMPLE OF STABILIZATION 1> in FIG. 6, the user 30 stabilizes his/her face on the face-stabilizing device 40. To be more specific, the user aligns a face-stabilizing characteristic point (for example, the space between the eyebrows also known as the glabella) with a predetermined position of the face-stabilizing device 40, adjusts a predetermined position of the face-stabilizing device (for example, the position to place the chin), and aligns a face-stabilizing characteristic point (for example, the jaw) with the predetermined position. The area determining part 102 specifies the coordinates of the predetermined positions of the face-stabilizing device 40 as the coordinates of the positions of the face-stabilizing characteristic points. The area determining part 102 calculates information (X-axis, Y-axis, and Z-axis coordinate information) about the three-dimensional shape of the area where the application part 12 applies the cosmetic product, based on the coordinates of the face-stabilizing characteristic points, and the relative positional relationship between at least two application characteristic points and the face-stabilizing characteristic points.

<Example of Stabilization 1 (when Searching for the User 30's Face-Stabilizing Characteristic Points)>

As shown as <EXAMPLE OF STABILIZATION 1> in FIG. 6, the user 30 stabilizes his/her face on the face-stabilizing device 40. The area determining part 102 specifies the coordinates of the positions of face-stabilizing characteristic points from the three-dimensional shape information measured from the user 30. The area determining part 102 calculates information (X-axis, Y-axis, and Z-axis coordinate information) about the three-dimensional shape of the area where the application part 12 applies the cosmetic product, based on the coordinates of face-stabilizing characteristic points, and the relative positional relationship between at least two application characteristic points and the face-stabilizing characteristic points.

<Example of Stabilization 2 (when the User 30's Face is Aligned with a Predetermined Position)>

As shown as <EXAMPLE OF STABILIZATION 2> in FIG. 6, the user 30 puts on a wearable device having an application part 12 and a 3D scanner 20. To be more specific, the user 30 aligns a face-stabilizing characteristic point (for example, the space between the eyebrows also known as the glabella) to a predetermined position of the wearable device, adjusts a predetermined position of the wearable device (for example, a movable part of the wearable device), and aligns a face-stabilizing characteristic point (for example, the jaw) with the predetermined position. The area determining part 102 specifies the coordinates of the predetermined positions of the wearable device as the coordinates of the positions of the face-stabilizing characteristic points. The area determining part 102 calculates information (X-axis, Y-axis, and Z-axis coordinate information) about the three-dimensional shape of the area where the application part 12 applies the cosmetic product, based on the coordinates of the face-stabilizing characteristic points, and the relative positional relationship between at least two application characteristic points and the face-stabilizing characteristic points.

<Example of Stabilization 2 (when Searching for the User 30's Face-Stabilizing Characteristic Points)>

As shown as <EXAMPLE OF STABILIZATION 2> in FIG. 6, the user 30 puts on a wearable device having an application part 12 and a 3D scanner 20. The area determining part 102 specifies the coordinates of the positions of face-stabilizing characteristic points from the three-dimensional shape information measured from the user 30. The area determining part 102 calculates information (X-axis, Y-axis, and Z-axis coordinate information) about the three-dimensional shape of the area where the application part 12 applies the cosmetic product, based on the coordinates of face-stabilizing characteristic points, and the relative positional relationship between at least two application characteristic points and the face-stabilizing characteristic points.

In this way, according to <<Case in which cosmetic product is applied separately after application characteristic points are identified», it is possible to use characteristic points that are registered in advance (that is, before the user 30 puts makeup on using the automatic makeup machine 10), so that it is not necessary to spend time identifying characteristic points.

Referring back to FIG. 2, the command part 103 commands the application part 12 to apply the cosmetic product to the area selected by the area determining part 102. Upon receiving the command, the application part 12 applies the cosmetic product to the specified area, following the command from the command part 103.

The command part 103 may command applying the cosmetic product in a uniform amount in all parts of the area to apply the cosmetic product, or command applying the cosmetic product in a larger amount in some parts of the area to apply the cosmetic product and applying the cosmetic product in a smaller amount in other parts.

The command part 103 can also be configured to command applying a cosmetic product of a color selected following the user 30's choice, or applying a cosmetic product of a color that the control part 11 selects as suitable for the user 30's face.

<Makeup with Multiple Types of Cosmetic Products>

According to one embodiment of the present disclosure, the automatic makeup machine 10 can also be configured to apply a number of types of cosmetic products (for example, foundation, eyebrow, eyeshadow, lipstick, and so forth). In this case, given a number of types of cosmetic products, the area determining part 102 determines the area for each cosmetic product based on at least two application characteristic points and an application pattern that is selected. The command part 103 commands the application part 12 to apply each of type of cosmetic product to the area for that cosmetic product. Note that the application pattern storage part 105 stores information of each cosmetic product's application pattern (the type of the shape of the area to apply each cosmetic product and the position on the face).

<Simulation>

According to one embodiment of the present disclosure, the automatic makeup machine 10 can also be configured to display, before the application part 12 applies a cosmetic product to the face of the user 30, a simulation image of applying the cosmetic product. In this case, the area determining part 102 displays an image of a simulation, in which the cosmetic product is applied to the user 30's face, on the display means of the automatic makeup machine 10, or on a display means that is connected to the automatic makeup machine 10. As described above, according to one embodiment of the present disclosure, the automatic makeup machine 10 can give the user 30 an idea of how the makeup will look when finished.

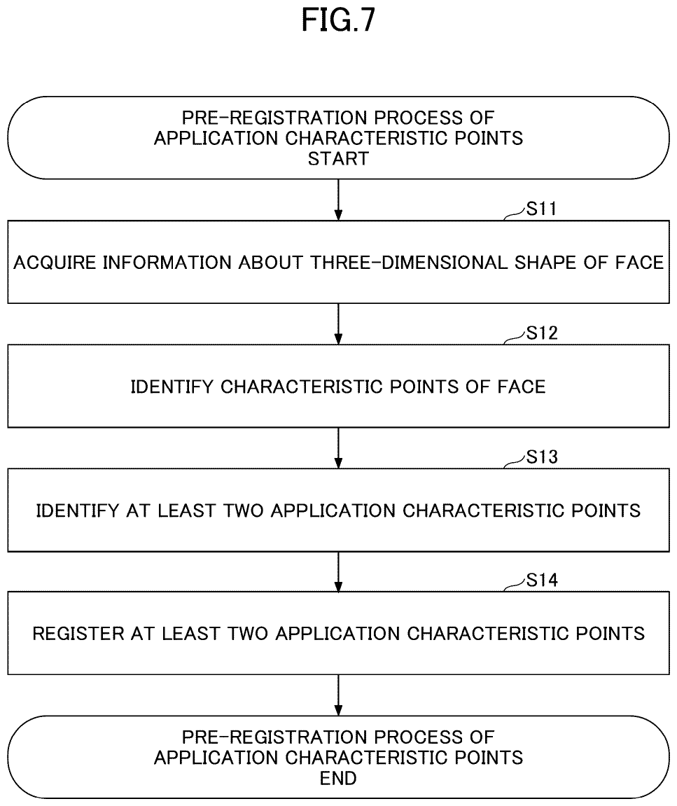

FIG. 7 is a flowchart showing an example pre-registration process of application characteristic points according to one embodiment of the present disclosure.

In step 11 (S11), the characteristic point registration part 101 acquires information (X-axis, Y-axis, and Z-axis coordinate information) about the three-dimensional shape of the user 30's face, measured using the 3D scanner 20.

In step 12 (S12), the characteristic point registration part 101 identifies characteristic points that indicate parts of the user 30's face, such as contours, eyes, nose, mouth, and eyebrows, based on the information about the three-dimensional shape of the user 30's face acquired in S11.

In step 13 (S13), the characteristic point registration part 101 identifies at least two application characteristic points among the characteristic points that indicate parts of the user 30's face such as contours, eyes, nose, mouth, and eyebrows, and that is identified in S12.

In step 14 (S14), the characteristic point registration part 101 registers the at least two application characteristic points identified in S13, with the characteristic point storage part 104.

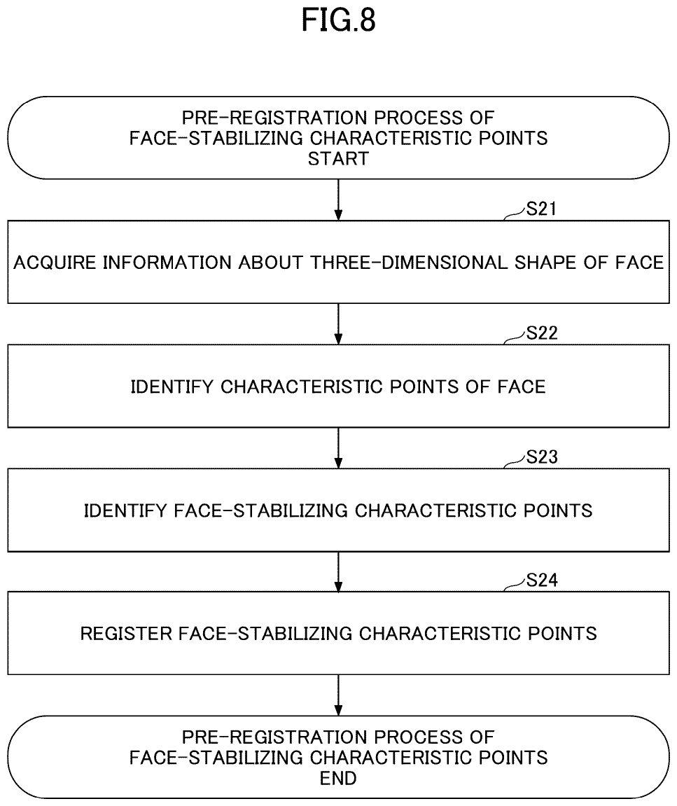

FIG. 8 is a flowchart showing an example pre-registration process of face-stabilizing characteristic points according to one embodiment of the present disclosure.

In step 21 (S21), the characteristic point registration part 101 acquires information (X-axis, Y-axis, and Z-axis coordinate information) about the three-dimensional shape of the user 30's face, measured using the 3D scanner 20.

In step 22 (S22), the characteristic point registration part 101 identifies characteristic points that indicate parts of the user 30's face such as contours, eyes, nose, mouth, and eyebrows, based on the information about the three-dimensional shape of the user 30's face acquired in S21.

In step 23 (S23), the characteristic point registration part 101 identifies face-stabilizing characteristic points (for example, two face-stabilizing characteristic points) from the characteristic points that indicate parts of the user 30's face such as contours, eyes, nose, mouth, and eyebrows, and that is identified in S22.

In step 24 (S24), the characteristic point registration part 101 registers the face-stabilizing characteristic points identified in S23 with the characteristic point storage part 104.

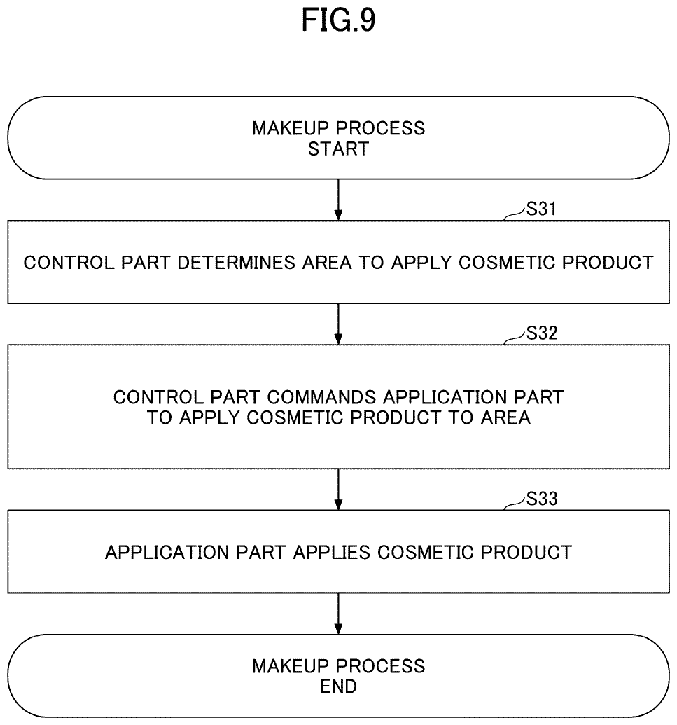

FIG. 9 is a flowchart showing an example makeup process according to one embodiment of the present disclosure.

In step 31 (S31), the area determining part 102 of the control part 11 determines the area to apply a cosmetic product.

In step 32 (S32), the command part 103 of the control part 11 commands the application part 12 to apply the cosmetic product to the area determined in S31.

In step 33 (S33), the application part 12, as commanded by the command part 103 in S32, applies the cosmetic product to the area specified in S32.

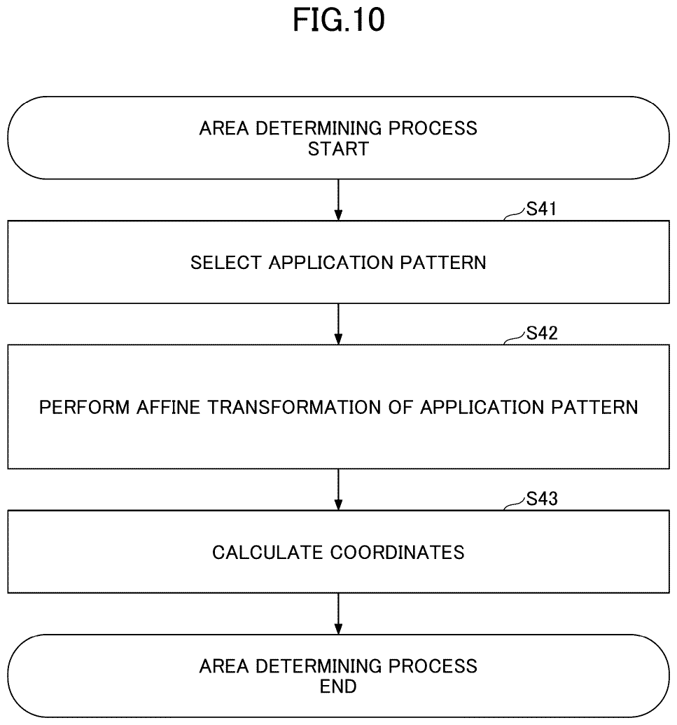

FIG. 10 is a flowchart showing an example area determining process (S31 in FIG. 9) according to one embodiment of the present disclosure.

In step 41 (S41), the area determining part 102 selects the application pattern. For example, the area determining part 102 can select an application following the user 30's choice. Also, for example, the area determining part 102 can select an application pattern based on characteristic points the user 30's face.

In step 42 (S42), the area determining part 102 performs an affine transformation of the application pattern selected in S41, based on the positions of at least two application characteristic points on the user 30's face.

In step 43 (S43), the area determining part 102 calculates the coordinates for specifying the area to apply the cosmetic product. When the cosmetic product is applied at the same time as characteristic points are identified, the area determining part 102 calculates the coordinates for specifying the area to apply the cosmetic product, based on the coordinates of at least two application characteristic points (that is, the area according to the application pattern that is affine-transformed and placed on the face in S42). When the cosmetic product is applied separately after characteristic points are identified, the area determining part 102 calculates the coordinates for specifying the area to apply the cosmetic product, based on the coordinates of face-stabilizing characteristic points and the relative positional relationship between at least two application characteristic points and the face-stabilizing characteristic points (that is, the area according to the application pattern that is affine-transformed and placed on the face in S42).

<Advantage>

As described above, according to one embodiment of the present disclosure, an application pattern that is selected by the user 30 or the automatic makeup machine 10 based on the positions of at least two application characteristic points is subjected to an affine transformation and then placed on the face, so that it is possible to select an area that is suitable for the face of each person having makeup put on.

Ident

<Hardware Structure>

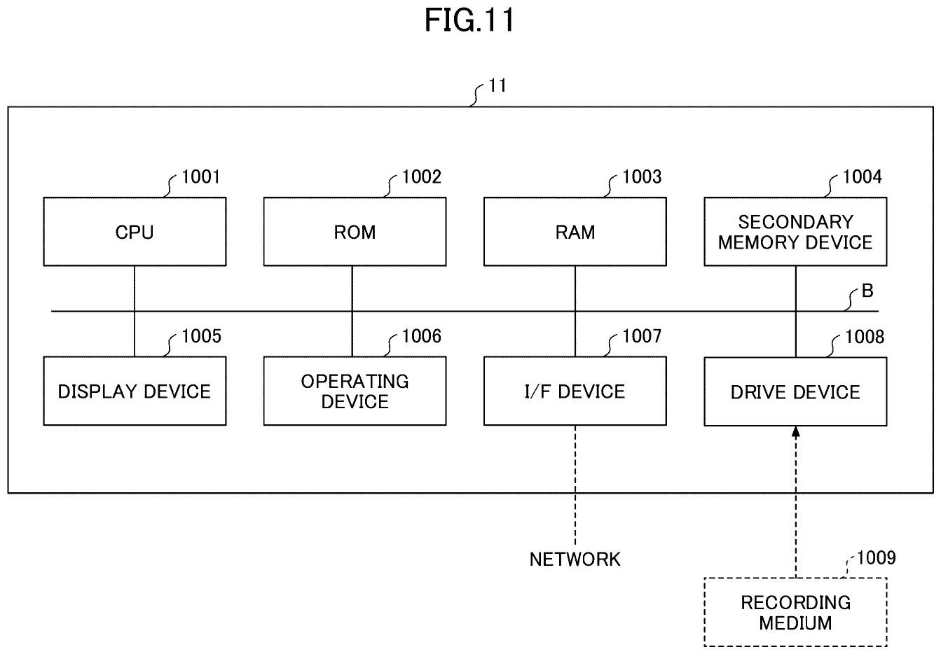

FIG. 11 is a block diagram showing an example hardware structure of the control part 11 according to one embodiment of the present disclosure (or, if the automatic makeup machine 10 is implemented using separate devices (a control device and an application device), the control device). The control part 11 and the control device include a CPU (Central Processing Unit) 1001, a ROM (Read Only Memory) 1002, and a RAM (Random Access Memory) 1003. The CPU 1001, the ROM 1002, and the RAM 1003 constitute what is known as a computer.

Furthermore, the control part 11 and the control device can include a secondary memory device 1004, a display device 1005, an operating device 1006, an I/F (Interface) device 1007, and a drive device 1008. Note that the control part 11 and each hardware of the control device are connected with each other via a bus B.

The CPU 1001 is an arithmetic-and-logic device that executes various programs installed in the secondary memory device 1004.

The ROM 1002 is a non-volatile memory. The ROM 1002 functions as a main memory device for storing various programs, data, and so forth that the CPU 1001 requires when executing various programs installed in the secondary memory device 1004. To be more specific, the ROM 1002 functions as a main memory device for storing, for example, boot programs such as BIOS (Basic Input/Output System), EFI (Extensible Firmware Interface), and so forth.

The RAM 1003 is a volatile memory such as a DRAM (Dynamic Random Access Memory), a SRAM (Static Random Access Memory), and so forth. The RAM 1003 functions as a main memory device to provide the work area that is expanded when various programs installed in the secondary memory device 1004 are executed on the CPU 1001.

The secondary memory device 1004 is a secondary memory device that stores various programs and information for use when various programs are executed.

The display device 1005 is a display device that displays the control part 11 and the internal state of the control device.

The operating device 1006 is an input device to allow the user 30 to input various commands in the control part 11 and the control device.

The I/F device 1007 is a communication device for connecting with the network and communicating with the application part 12, the 3D scanner 20, and so forth.

The drive device 1008 is a device for setting up the recording medium 1009. The recording medium 1009 referred to here includes a medium on which information is recorded optically, electrically, or magnetically, such as a CD-ROM, a flexible disk, a magneto-optical disk, and so forth. Furthermore, the recording medium 1009 may include a semiconductor memory or the like that records information electrically, such as an EPROM (Erasable Programmable Read Only Memory), a flash memory, and so forth.

Note that various programs are installed on the secondary memory device 1004 by, for example, setting a distributed recording medium 1009 in the drive device 1008, and reading various programs recorded on this recording medium 1009 by means of the drive device 1008. Alternatively, various programs to be installed in the secondary memory device 1004 may be downloaded from the network via the I/F device 1007.

Although an embodiment of the present disclosure has been described in detail, the present disclosure is by no means limited to the specific examples described herein, and various variations and modifications can be made within the scope of the herein-contained claims.

This international application is based on and claims priority to Japanese Patent Application No. 2019-187736, filed on Oct. 11, 2019, and the entire contents of Japanese Patent Application No. 2019-187736 are incorporated herein by reference.

### REFERENCE SIGNS LIST

10 Automatic makeup machine
11 Control part
12 Application part
20 3D scanner
30 User
40 Face-stabilizing device
101 Characteristic point registration part
102 Area determining part
103 Command part
104 Characteristic point storage part
105 Application pattern storage part

1. An automatic makeup machine comprising a control part and an application part,
wherein the control part includes:
an area determining part configured to determine an area to apply a cosmetic product, based on a selected application pattern and at least two application characteristic points on a face; and
a command part configured to command the application part to apply the cosmetic product to the area,
wherein the application part applies the cosmetic product to the area as commanded by the control part.

2. The automatic makeup machine according to claim 1,
wherein the control part further includes a characteristic point registration part configured to have the at least two application characteristic points and a face-stabilizing characteristic point registered with the characteristic point registration part in advance, the face-stabilizing characteristic point being different from the application characteristic points, and
wherein the area determining part calculates coordinates for specifying the area to apply the cosmetic product, based on coordinates of the face-stabilizing characteristic point and a relative positional relationship between the at least two application characteristic points and the face-stabilizing characteristic point.

3. The automatic makeup machine according to claim 1, wherein the area determining part performs an affine transformation of the application pattern and places the application pattern on the face.

4. The automatic makeup machine according to claim 1, wherein the application part applies the cosmetic product to the area by spraying the cosmetic product.

5. The automatic makeup machine according to claim 1,
wherein the cosmetic product includes a plurality of types of cosmetic products,
wherein the area determining part determines an area for each cosmetic product, based on a selected application pattern and at least two application characteristic points for each cosmetic product, and
wherein the command part commands the application part to apply each cosmetic product to the area for each cosmetic product.

6. The automatic makeup machine according to claim 1, wherein the automatic makeup machine displays an image of a simulation of applying the cosmetic product.

7. A method comprising:
determining an area to apply a cosmetic product based on a selected application pattern and at least two application characteristic points on a face; and
applying the cosmetic product to the area.

8. A non-transitory recording medium having a program stored therein for causing a control part, configured to give a command to an application part, to function as:
an area determining part configured to determine an area to apply a cosmetic product, based on a selected application pattern and at least two application characteristic points on a face; and
a command part configured to command an application device to apply the cosmetic product to the area.

9. A control device comprising:
an area determining part configured to determine an area to apply a cosmetic product, based on a selected application pattern and at least two application characteristic points on a face; and
a command part configured to command an application device to apply the cosmetic product to the area.
